(19) United States
(12) Patent Application Publication
(10) Pub. No.: US 2018/0322554 A1
(43) Pub. Date: Nov. 8, 2018

(54) Personalized Gift System and Method

(71) Applicants: Lily Ann Born, Skokie, IL (US); Joseph Born, Lincolnwood, IL (US)

(72) Inventors: Lily Ann Born, Skokie, IL (US); Joseph Born, Lincolnwood, IL (US)

(21) Appl. No.: 15/584,502

(22) Filed: May 2, 2017

(51) Int. Cl. G06Q 30/06

(52) U.S. Cl. CPC G06Q 30/0621

(57) ABSTRACT

A system and method for giving a physical gift such as a coffee cup, item of clothing or jewelry to another with an associated website that contains information about the gift. A gift item has a unique identification stamped or permanently printed on it. Each gift item can also have the URL of a webpage as well. Upon gifting the item, extra data such as wishes, photos and the like may be logically attached to the particular physical gift through the website. Any owner of the gift, past, current or future will be able to access all of the information concerning that particular gift. The invention encourages recipients to contribute their own pictures and commentary thereby facilitating communications back to the gift giver like a chain letter that provides feedback to the original letter writer inducing them and new recipients to continue to participate in the gift giving cycle.

### BACKGROUND

### Field of the Invention

The present invention relates generally to gifts and social media and more particularly to a personalized gift system and method that creates a relationship between a physical gift and a web site.

### Description of the Problem Solved

Personalized gifts are known in the art. Sometimes gifts have a recipient's name on them, or a special message from the giver. In other cases, there may be a poem or biblical verse possibly followed by a message. Some gifts are personalized by their shape or relationship with a recipient's occupation or profession. Other gifts, such as coffee cups or tee-shirts, may have photos, letters, formulas, symbols and many other types of personalizations. There are many types of gifts such as books, clothing, accessories like bracelets or necklaces, rings, and many other forms. A particularly attractive and useful gift is a coffee cup. It should be noted that while coffee cups are used in examples of embodiments of the present invention, any other type of physical gift is within the scope of the present invention in its various embodiments.

Social media running from various platforms and websites is currently very popular. Users or subscribers can upload photos, text, stories, video, music and any other manner of expression to their personalized accounts on sites or to general sites that allow the exchange of information. Presently, there is no connection between physical gifts and social media.

Prior art personalized gifts have the disadvantage of usually having permanent markings for the personalization. This prevents re-gifting the item since these markings cannot be removed. Also, there is no way to enhance the gift giving experience by adding more information about the gift as it is given and possibly re-given. It is also impossible for the giver to trace the history of a gift and its previous owners or its later travels and owners since the giver loses control over the gift as soon as it is given, and typically has no way to know its past. It would be advantageous to have a physical gift whose history can be traced and accessed by the recipient, whose personalization can be changed or augmented, and whose future ownership and travels can be accessed. It would also be very advantageous to be able to connect the physical gift with photos, poems, music, stories, history of the gift and the like without having to physically alter the item. Finally, it would be useful to be able to dynamically create, grow and maintain a chain of relationships between various givers and recipients of the gift; this can be connected to the gift's travels and locations if so-desired by the various owners.

A perfect example of a personalized drink cup was a cup found in the ruins of ancient Olympus in Greece. The cup has the name Phidios inscribed on it. It is known that Phidios was the great sculptor of that area and time. The disadvantages of this type of personalization are obvious; there is no way to know who owned the cup before Phidios, and there is no way to know if it was a gift or not. Other than the fact if was buried in the ruins, there is no way to know whether Phidios kept it himself or possibly gifted it to a successor. In fact, it is not entirely possible to know if this cup belonged to the sculptor or to another person with that name. While clearly impossible in antiquity, today with the advent of the computer and Internet, the present invention makes it possible to entirely track a physical gift or object from the time of manufacture through a chain of ownership along with all types of extra, interesting information.

### SUMMARY OF THE INVENTION

The present invention relates to various embodiments of a system and method of making and tracking a personalized gift. A gift item, such as a coffee cup or other object has an identification stamped or permanently printed on it. This can be a simple number in some embodiments. Each gift item can also have a URL address of a webpage as well. For example, a coffee cup might be stamped as number 72 followed by the URL of the site that can contain all manner of information and tracking relating to cup number 72. In lieu of a URL, a QR code may also be used. The initial data may simply be the date and place of manufacture, or it may be more complex. Upon gifting the cup, extra data, wishes, photos and the like may be logically attached to cup number 72 through the website. Any owner of the gift, past, current or future will be able to access all of the information concerning that particular gift. Again, while a coffee cup has been used as an example, any type of physical gift is within the scope of the present invention.

Since, gifting and re-gifting creates a chain, it is possible to substitute alternate or different gifts into the same chain.

Therefore, an object of the present invention is to provide a way to personalize a gift that ties it to a customized website.

It is a further object of the invention to provide a way for multiple users to contribute to the customized website associated with the gift (this contribution will typically take the form of adding pictures and commentary to website).

It is a further object of the invention that when photographed and shared, the link to the customized website will be preserved.

It is a further object of the invention that the gift and associated custom website will encourage recipients to contribute their own pictures and commentary thereby facilitating communications back to the gift giver, much in the spirit of a chain letter that provides feedback to the original letter writer inducing them and new recipients to continue to participate in the gift giving cycle.

It is a further object of the invention that it facilitate the re-gifting of the gift by creating an interactive, permanent thread that will track the progress and history of the gift, which, upon re-gifting, includes them as both recipient and giver of the gift.

Finally, It is an object of the invention that it facilitate the “virtual” re-gifting of the object by creating an association between each recipient and the next, even if the physical object originally received is not identical to the one given to the next recipient. Thus even when the “cycle of giving” involves multiple recipients and multiple different gifts, a chain of the related gifts can be preserved.

### DESCRIPTION OF THE FIGURES

Attention is now directed to several figures that illustrate features of the present invention:

FIG. 1 shows an example of a web page associated with a physical gift.

FIG. 2 shows a web page with buttons to other social media.

FIG. 3 shows a pre-populated dialog box.

FIG. 4 shows notation on a web page for a child cup.

FIG. 5 shows notation on a cup's page showing it is a child cup.

Several drawings and illustrations have been presented to aid in understanding the present invention. The scope of the present invention is not limited to what is shown in the figures.

### DESCRIPTION OF THE PREFERRED EMBODIMENTS

The present invention relates to a personalized gift system and method where physical gifts such as coffee cups, clothing, jewelry and the like are manufactured with a permanent particular identification that can be a simple number, or a more complex identification, and a link to a website that can be a URL, QR code or any other type of link or pointer.

A server computer connected to a network such as the Internet executes stored instructions in a known manner to host a website. The website is accessible to remote user computers or telephones by the URL, QR code or other link. Before a particular gift is first given, the owner can access the website and retrieve data from a database on the server using the identification on the physical gift. The database is stored in a memory device accessible by the server and indexed according to the identifications of the gifts. A chain of information can thereby be obtained that includes the initial manufacturing information including the date and place of manufacture, and any data entered by previous owners if any. The giver can then store information about the gift, photos, wishes and any other type of description or data that the giver wishes to convey to the recipient or to even more remote future owners. The recipient can also access the site and enter messages and data intended for the giver such as thanks, or how the gift will be used, or photos of the gift being used, or any other information about the gift. The chain can grow if the gift is re-gifted with all of the owners past and present being able to communicate.

The following gives examples of particular embodiments of the present invention. The examples use coffee cups as physical gifts. Any physical object that can include a permanent identification and link to a website is within the scope of the present invention.

Cups are individually printed and distributed with text and an easily visible mark, for example

### #CupOfImagination

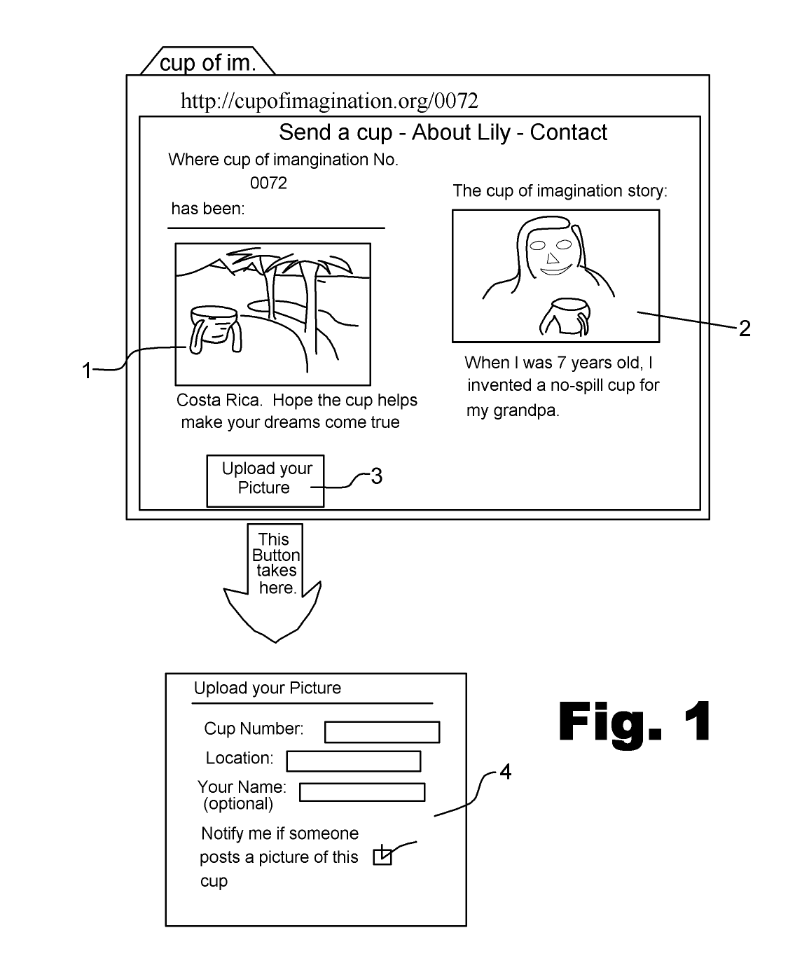

No. 0072
This cup has a story: http://CupOfImagination.org/0072
Each cup will be serialized, in other words have its own number (0072 being simply one example). When the user goes to the individual site listed on the cup (in the above example: http://CupOfImagination.org/0072 They will see the website of FIG. 1.

FIG. 1 shows a web page that has a history 1 of the cup, some personal information about the owner 2 and a link 3 to a menu 4 that allows a giver or recipient to upload more information about cup #72.

It should be appreciated that mark on the cup serves several purposes: First, it identifies the cup uniquely and prominently. Second, it guides the user to an associated web page or set of web pages, either directly (through the URL or an associated QR code or the like), or indirectly as when the user searches for #cupofimagination on a search engine or social media site. In either case, a user in possession of the cup, or viewing the cup on social media, will be able to easily research the origin of the cup, and with limited effort, find the cupofimagination.org site and locate the specific cup's page.

The following is an example of a user scenario for a cup:

A purchaser of the cup wants to leave the cup behind for a server at a restaurant as a gift, the server having mentioned the desire to return to school when enough money has been saved. The giver takes a photo of the cup at that restaurant and uploads it to the website with an accompanying note, “I hope this cup helps you imagine something in your future, like going back to school”. The server gets the cup, goes to cupofimagination.org/0072 and sees the web page that has the above message along with other information about the cup. In this scenario, it can be seen that the combination of the serialized cup and personalized website has several benefits:

First, it allows for the spontaneous giving of a customized physical gift without the need for the customized physical product to be produced and shipped; the manufacturer simply needs to serialize the items in mass production. The holder of the item does not have to plan in advance the messaging on the gift; they can decide at the moment of the gift by populating the website with pictures, videos and text. While the content of the customization is provided digitally, there is a direct connection to the physical object via the ID and URL displayed on the object.

Second, it provides an easy mechanism for interactivity and feedback. Continuing the example: The recipient in turn, uploads her picture of the cup with her own message. “Thanks so much. I′m going to give this cup to my aunt; she's always wanted to go to Tibet. This will remind her what's possible.” When her aunt receives the cup, she will see both messages, with her nieces (the most recent) at the top. In many cases, it may be preferable to have the most recent picture at the top of the page by virtue of likelihood of being the most pertinent to the recipient.

An alternate embodiment of the present invention encourages users to post on social media networks of their choosing with hashtags that allow the aggregation into one website. For example users could post with #cupofimagination #0072 or #COI0072 on Instagram (™), Facebook(™) or Twitter(™) and the cupofimagination.org/0072 website can aggregate all those messages into one stream arranged by date. As an alternative to scanning for hashtags, an application with object and text recognition capabilities can scan web images for the presence of that object and serial number.

It is also possible that a user can post a link to the social media post to the cupofimagination.org site with the appropriate cup number to manually facilitate the inclusion of the above social media links. In other words, in addition to a user being able to post photos and videos and comments, the user can simply post links.

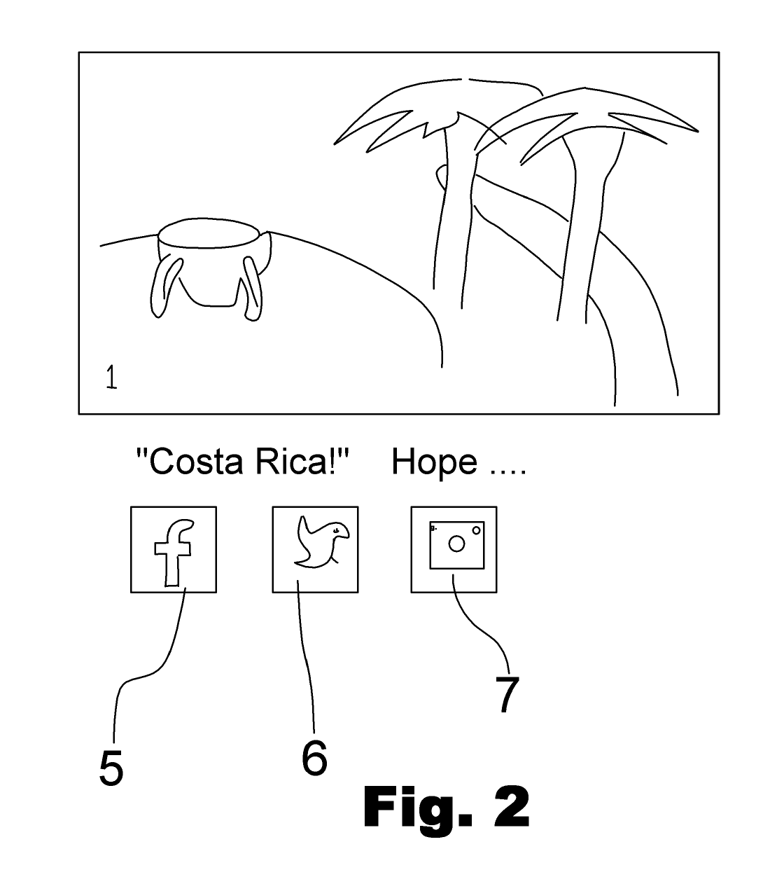

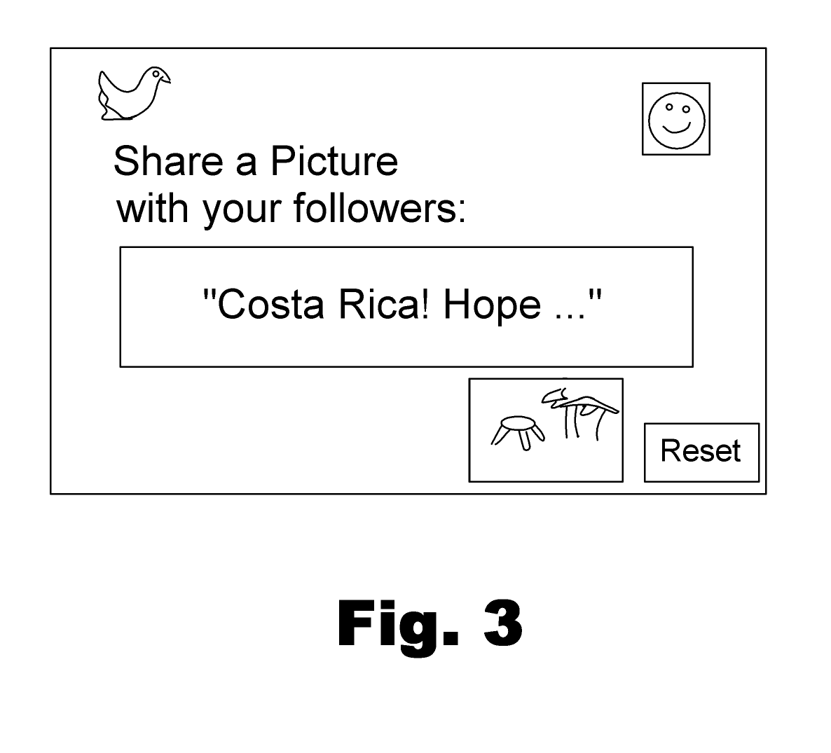

It should be appreciated that it is also desirable that the cupofimagination.org website can facilitate posting to other social networks as well as shown in FIG. 2. Buttons 5, 6 and 7 transfer access to social media sites. For example, clicking on the twitter(™) button for example can bring up the well known pre-populated posting dialog box facilitating the post and reducing effort for the user as shown in FIG. 3.

In another embodiment of the invention, the user may wish to upload a picture of the cup with a backdrop that is not available to them, either because they don't have the cup present when in that location, or because they have not actually been to that location. For example, the user wishes to purchase a cup, and the merchant selling the cup will be instructed to send that cup directly to the desired recipient rather than the actual purchaser. In that case, the purchaser never actually takes possession of the cup. Nonetheless, the purchaser would like to seed the recipient's imagination with a visual representation. For example, a woman has not been able to complete the El Camino de Santiago de Compostela journey, so her friend, to give encouragement, wants to send a cup to her with a picture of her cup superimposed over the steps of The Cathedral of Santiago de Compostela where the journey will terminate. In this case, the purchaser visits the merchant's site where the cup is available for sale. The merchant ships the cup to the recipient and provides the cup serial number to the purchaser, along with a link that allows not only a picture of the user's choosing to be uploaded, but the ability to superimpose the picture of that serialized cup on the picture. The technology for such superimposing via web application is known in the art, and it used, among other places by eyeglass sites for virtual “try ons,” wherein, the user uploads a picture of themselves and then superimposes various frames on their picture to see what they look like on them. The posting of such images can also be combined with the customization of the cup itself. It is possible that in addition to the serialized text placed on the web page, a set of personalized text and or images can also be included. In the above example, the gifted cup could include the image of a loved one with a message that included “in memory of” and the loved one's name.

In another embodiment of the invention, the recipient of the cup chooses that rather than physically gifting the cup they have received, they would prefer to virtually give a cup, perhaps because they would like to keep the cup they have received, or perhaps because they are not physically in contact with the desired recipient. In this case, a “forward” link can be provided on the website in the comment section that links to the new cup being gifted.

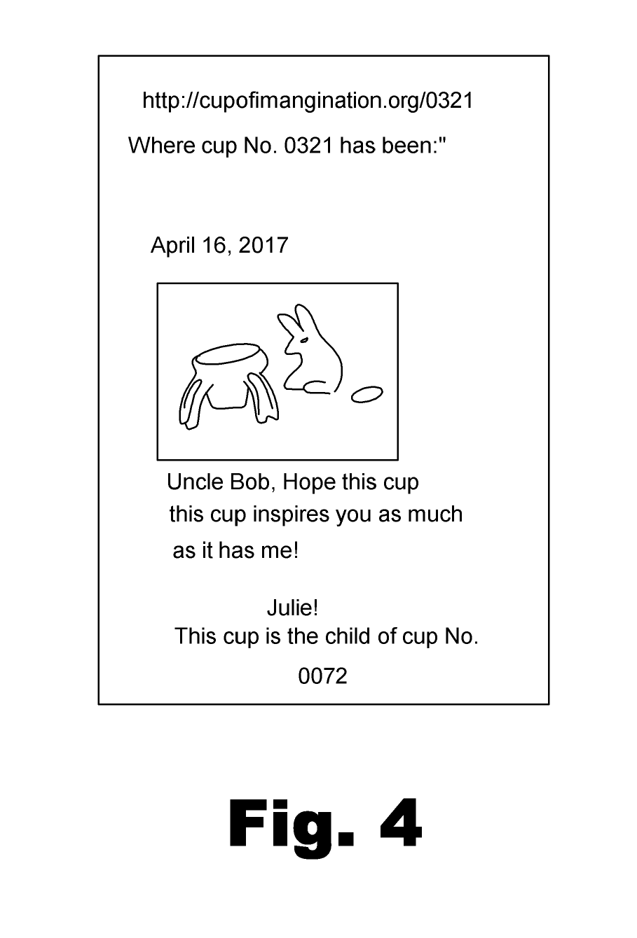

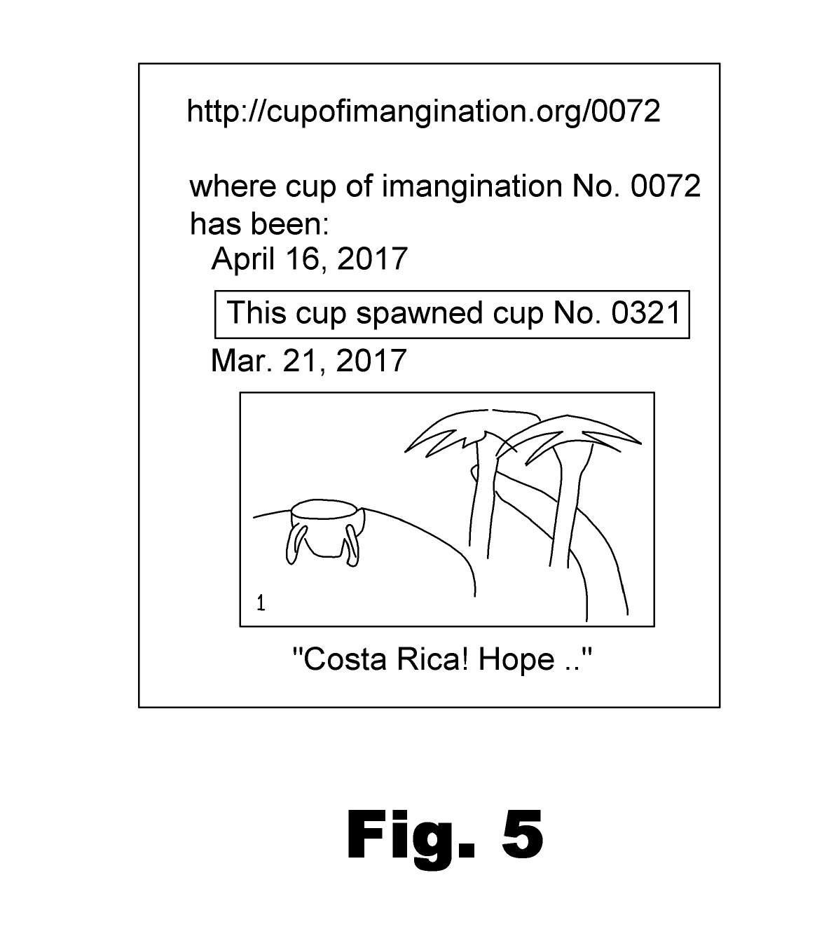

It is possible (though not necessary) that the new cup could present a notation on the cup itself of its association with a previous cup such as below
#CupOfImagination
   No. 0321
   (was No. 0072)
This cup has a story: http://CupOfImagination.org/0321
In either case, the customized web pages (or sites) of both cups would preserve a link, such as shown in FIG. 4. Any interested viewer can click on the link underlined, ie “this cup is the child of Cup No 0072” and be taken to the page http://cupofimagination.org/0072 shown in FIG. 4. As seen in the in FIG. 5, http://cupofimagination.org/0072 now shows a “forward” link to cup no 0321 as a cup that has been “spawned” by cup no 0072.

For the purchaser, this process can be automatic, i.e., if they had already logged in and posted a picture of cup 0072 and then are purchasing a new cup, the merchant site can automatically populate the links to both the pages for cup numbers 0072 and 0321. If the user was not logged in, or had not posted previously, a field could be provided by the merchant that would allow the purchaser to designate the new gifted cup as a child of the previously received cup.

In another embodiment of the invention, Instead of a third party application that would scan the social media networks for the appropriate hashtags to integrate, an application (App) on a portable telephone could have text and object recognition that will, at the time of the photo being taken, identify the object and serial number and automatically prompt the user to post directly to the correct website.

In another embodiment of the invention, the gift only has an identification. Instructions pointing to the web page can be supplied on printed instructions accompanying the gift. The advantage of this embodiment is that if the website changes, it is only necessary to print new instructions. Also, with this embodiment, different similar gifts can be pointed to different websites. A disadvantage is that the instructions can be lost. However, it is always possible to search for the cup website using a search engine known in the art.

In another embodiment, a giver could participate on the website of this invention with a gift of their own creation, such as a handmade cup labeled, for example, #CupOfImagination No. 738. They would separately visit the website and secure http://cupofimagination.org/738 for that gift, complete with all the photo and note sharing capabilities mentioned in the above examples. The process for allocating unique user selected names and/or serial numbers is well known, and has long been used for allocating usernames for emails and social media pages and the like. Such a real time process could be integrated with a manufacturing process that serialized goods, making the necessary accommodations for manufacturing lead times and such, perhaps by batch allocating a range of serial numbers well in advance.

It should be appreciated that such serialization of the cups would not need to be only numerical, but could be could contain alphabetic characters such as done elsewhere for social media and email names.

It should be noted that a server or server computer is a computer running special software that allows it to host websites. It is usually a larger, faster computer than many user devices, and it typically communicates with large storage devices such as disk drives or mass storage devices. It is usually activated and listens on one or more networks for page requests from its address. A website is a set of stored web pages that can be accessed by users with browser software. Like all modern computers, a server executes stored instructions from a memory device. A user typically accesses a website or web page from a user computer that is running browser software known in the art. A user computer can be a desktop, laptop, pad computer or telephone. The user computer usually communicates with any number of servers using Uniform Resource Locators (URLs) that are translated by the network into Internet Protocol (IP) addresses. A database is a set of stored data usually on a disk drive or mass storage device that is arranged and indexed for easy access and query of the stored data. Networks include Ethernet (TM) on cable or fiber optics; Sonet or wave division multiplex on cable or fiber optics or wireless techniques such as cellular telephone.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. A personalized gift giving system comprising:
a server computer coupled to a network executing stored instructions allowing the server to host a webpage, the server also having access to a database stored in a memory device accessible by the server;
a plurality of physical gifts, each gift including a physically marked identification and a physically marked link to said webpage;
the database being indexed by the identifications of each of the plurality of gifts, the database further containing data information about each of the plurality of gifts;
the stored instructions on the server allowing an owner of a particular physical gift of the plurality of gifts to enter and retrieve data about the particular gift to and from the database using the identification;
whereby, the particular physical gift may be gifted or re-gifted by subsequent owners, each owner able to enter and retrieve information about the particular gift thus creating a chain of ownership.

2. The system of claim 1 wherein at least one of the plurality of gifts is a drinking cup.

3. The system of claim 2 wherein all of the plurality of gifts are drinking cups.

4. The system of claim 1 wherein the link is a URL or QR code.

5. The system of claim 2 wherein the link is a URL or QR code.

6. The system of claim 1 wherein the information includes at least one photo.

7. The system of claim 6 wherein the information also includes text.

8. The system of claim 1 wherein the identification is a unique number.

9. The system of claim 1 wherein at least one of the plurality of gifts is a cup, the identification is a number and the link is a URL.

10. The system of claim 9 wherein the information includes at least one photo.

11. The system of claim 10 wherein the information also includes text.

12. A personalized gift system comprising:
a set of physical gifts each having a unique, non-removable ID on the gift itself;
a website having a URL hosted by a server computer in communication with a database, the database containing information for each of the physical gifts in the set;
the URL of the website being made available to a purchaser or recipient of any of the gifts in the set;
the information for each particular physical gift in the set accessible and update-able by a purchaser or giver or recipient of the particular gift on the website, wherein the information for each particular gift contains at least a history of ownership of the particular gift.

13. The system of claim 12 wherein the URL is also on the gift itself and is non-removable.

14. The system of claim 12 wherein the information for at least one of the gifts in the set includes at least one photo.

15. The system of claim 12 wherein the information for each particular gift includes photos and text.

16. The system of claim 12 wherein at least one of the physical gifts in the set is a cup.

17. The system of claim 12 wherein at least one of the physical gifts is an item of clothing or a piece of jewelry.

18. The system of claim 12 wherein pairs of gifts in the set can be related to one-another and where pages on the website like the pairs of related gifts.

19. A method of linking physical gifts to gift givers and recipients comprising:
supplying a particular physical gift to a gift giver from a set of physical gifts each having a non-removable identification and a link to a website;
entering information for each physical gift in the set into a database accessible on the website;
allowing the gift giver to access and update the information on the website concerning the particular physical gift;
allowing a gift recipient to also access and update the information on the website concerning the particular physical gift;
wherein, the information on the website concerning the particular physical gift contains at least a history of ownership of the particular gift.

20. The method of claim 19 wherein the particular physical gift is a cup.
